(19) United States
(12) Patent Application Publication
(10) Pub. No.: US 2012/0170031 A1
(43) Pub. Date: Jul. 5, 2012

(54) Industry Endoscope with a Rigid Body

(76) Inventor: Hsiang Te Tseng, New Taipei City (TW)

(21) Appl. No.: 13/100,251

(22) Filed: May 3, 2011

(30) Foreign Application Priority Data
Dec. 31, 2010 (TW) 099225712

(51) Int. Cl. G02B 23/26

(52) U.S. Cl. 356/241.5

(57) ABSTRACT

The present invention relates to an industry endoscope with a rigid body, which includes a base, a rod and a handle portion. One end of the base is horizontally connected to the rod having a knob. The handle portion is vertically connected to the base. The free end of the rod is provided with an inspection module. The rotation of the knob and the rod causes the inspection module to rotate 360 degrees relative to its axial line. In this way, the inspection module can be inserted to a small channel for precise inspection.

### BACKGROUND OF THE INVENTION

1. Field of the Invention

The present invention relates to an industry endoscope with a rigid body, and in particular to an endoscope having an inspection module capable of providing illumination and precise inspection.

2. Description of Prior Art

Many large-sized machines, such as heavy industry machines, motorcycles or other machines, are manufactured with an allowable tolerance. In order to achieve a better quality, various instruments are used for measuring, monitoring and correcting the finished machines.

Accordingly, special inspection instruments are proposed to inspect the interiors of the respective machines. When the conditions inside a small channel are to be inspected, traditionally, a camera is installed on one end of a flexible cable, and the camera is inserted into the small channel for inspection. However, since there is no light source in the small channel, an illumination device has to also be provided. Further, the flexible cable cannot be well controlled to inspect the interior of the small channel completely. Thus, it is an important issue for the present Inventor to solve the above-mentioned problems.

### SUMMARY OF THE INVENTION

In order to solve the above problems, an objective of the present invention is to provide an industry endoscope with a rigid body. The endoscope is substantially configured as an L-shaped gun and includes a base, a rod and a handle portion. One end of the base is connected to the rod. The free end of the rod is provided with an inspection module. The handle portion is vertically connected to the base. The inspection module comprises a lens and a plurality of light-emitting devices. Since the rod is rigid and straight, the rod can be inserted into a small channel for inspection, and the inspection module provides illumination so as to inspect the interior of the small channel more precisely.

### BRIEF DESCRIPTION OF THE DRAWINGS

FIG. 1 is a perspective view showing an industry endoscope with a rigid body according to the present invention;

FIG. 2A is a perspective view showing a cap connected to the industry endoscope with a rigid body according to the present invention;

FIG. 2B is a schematic view showing an inspection module of an industry endoscope with a rigid body according to the present invention;

FIG. 3 is a perspective view showing a connecting portion provided on one end of the base of an industry endoscope with a rigid body according to the present invention;

FIG. 4 is a perspective view showing an industry endoscope with a rigid body according to the present invention inserted into a channel for inspection;

FIG. 5A is a perspective view showing another cap connected to an industry endoscope with a rigid body according to the present invention;

FIG. 5B is a schematic view showing the cap of FIG. 5A;

FIG. 6A is a schematic view showing an industry endoscope of FIG. 2A inserted into a channel for inspection; and

FIG. 6B is a schematic view showing an industry endoscope of FIG. 5A inserted into a channel for inspection.

### DETAILED DESCRIPTION OF THE INVENTION

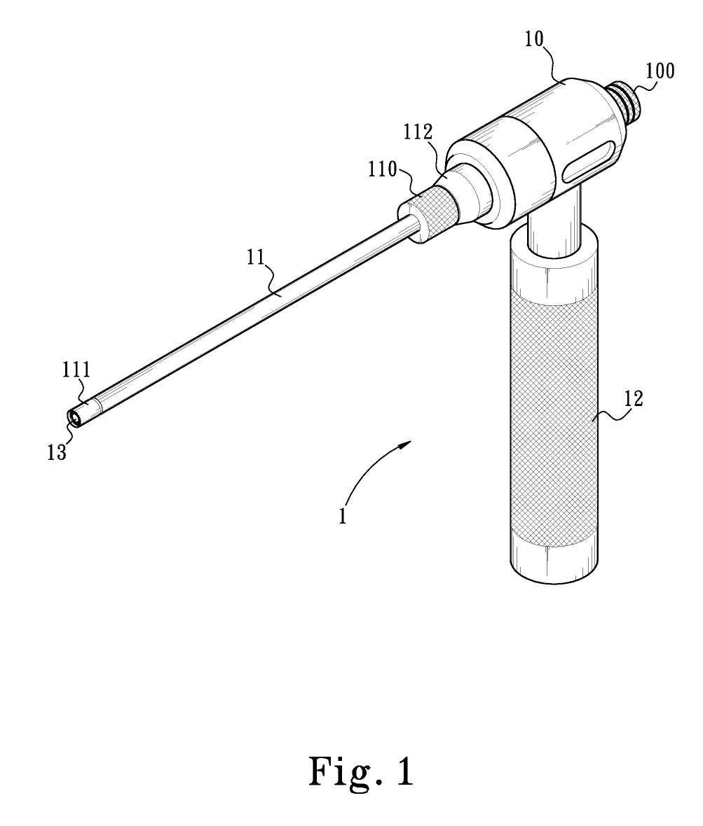

Please refer to FIGS. 1, 2A, 2B and 3. Embodiments of the present invention provide an industry endoscope with a rigid body. The endoscope 1 comprises a base 10, a rod 11 and a handle portion 12. The rod 11 is horizontally and rotatably connected to one end of the base 10. The handle portion 12 is vertically connected to the base 10. The rod 11 is a rigid straight rod, which is capable of rotating 360 degrees relative to its axial line, so that an inspection module 13 can inspect a forward location or different angular locations relative to the rod 11. In this way, the endoscope 1 can be inserted into a straight small channel for inspection purposes.

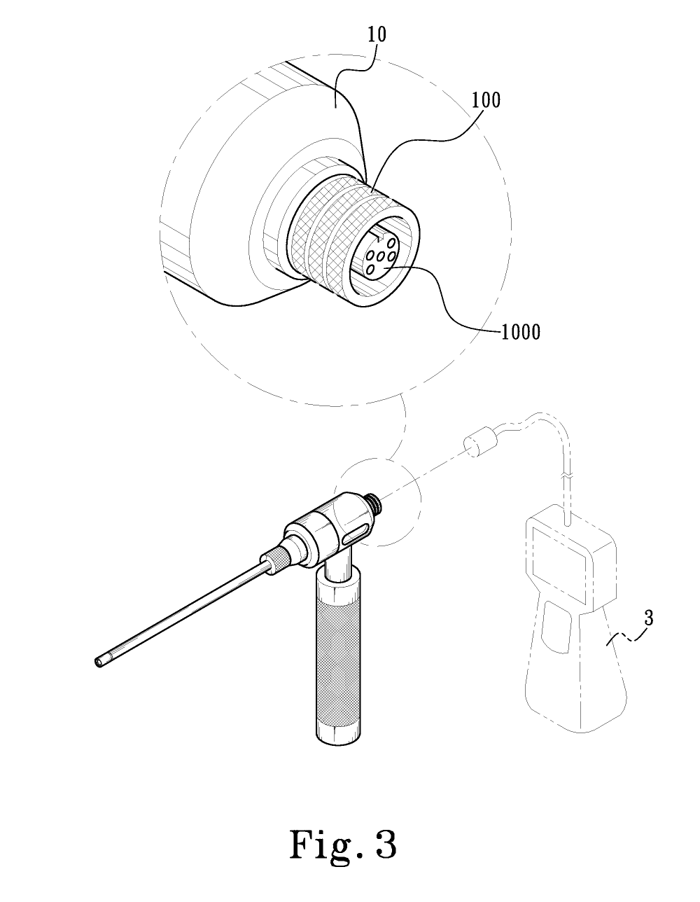

The base 10 is configured as a cylindrical body. A rear end of the base 10 is provided with a post-like connecting portion 100. The outer surface of the connecting portion 100 is provided with small protrusions to generate a slide-proof effect. The inner edge f the connecting portion 100 is formed with a plurality of terminals ports 1000 for connecting to a display device 3 (as shown in FIG. 3) having a power supply and video transmission means. The display device 3 is capable of taking pictures and recording what the inspection module 13 is inspecting. The front end of the base 10 is formed with a tapered post 112. One end of the tapered post 112 is connected to the rod 11 having a knob 110. The post-like handle portion 12 is connected to one side of the base 10. The interior of the base 10 is hollow, so that electrical wires can be received therein. With the rod 11 and the handle portion 12 connected to the base 10 respectively, a gun-like endoscope 1 is obtained.

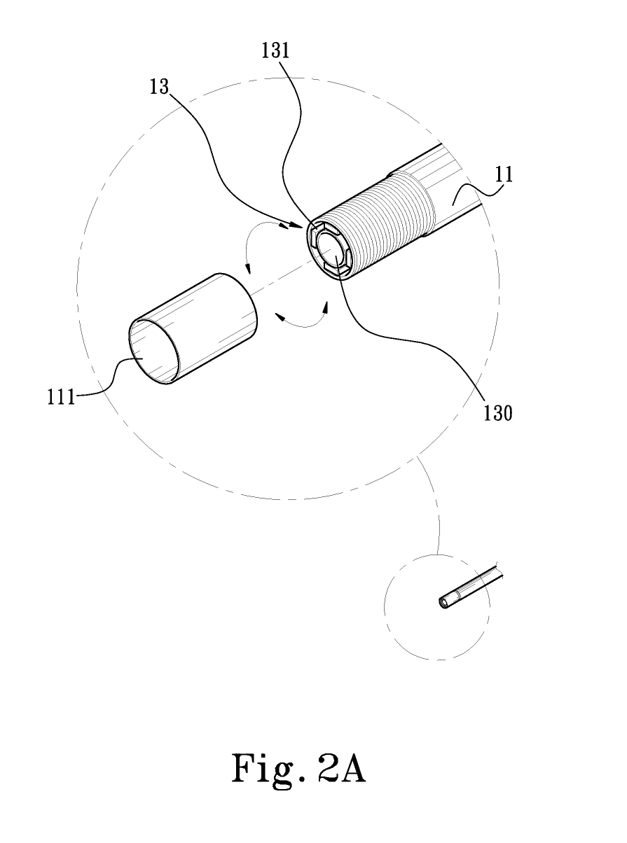

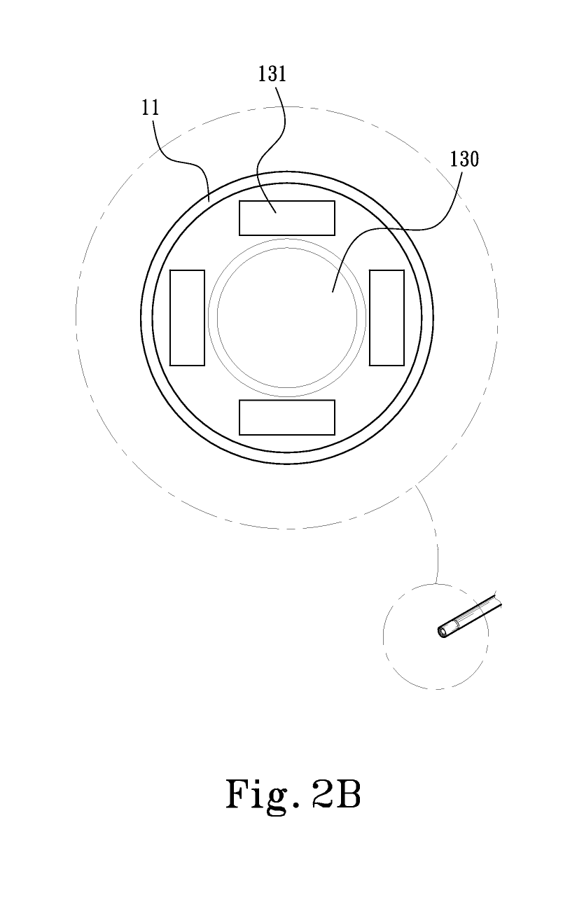

The rod 11 is a rigid, straight and hollow rod. One end of the rod 11 has the knob 11 for connecting to one end of the tapered post 112 of the base 10. The other end (i.e. the free end) of the rod 11 is provided with the inspection module 13. The outer surface of the free end of the rod 11 is provided with outer threads, so that a cap 111 can be threadedly connected to the free end of the rod 11 to thereby protect the inspection module 13. The inspection module 13 comprises a lens 130 and a plurality of light-emitting devices 131. The light-emitting devices 131 are provided on the outer periphery of the lens 130, so that the light-emitting devices 131 can provide illumination for the lens 130 when the inspection module 13 is inserted into a channel as shown in FIG. 2B. When a user rotates the knob 110, the rotation of the knob 110 can cause the rod 11 to rotate 360 degrees relative to its axial line, thereby inspecting different angular locations on the inner wall of the channel. The outer surface of the knob 110 is formed with small protrusions to increase the frictional force between the knob 110 and fingers, thereby generating a slide-proof effect.

The handle portion 12 is shaped as a post. One end of the handle portion 12 of a small diameter is connected to the base 10. The outer surface of the handle portion 12 is formed with small protrusions to increase the frictional force between the handle portion 12 and a hand, thereby achieving a slide-proof effect. The endoscope 1 of the present invention can be used in industry machines. One end of the straight rod 11 is provided with the inspection module 13, so that the inspection module 13 can be inserted into a small channel to inspect the conditions therein.

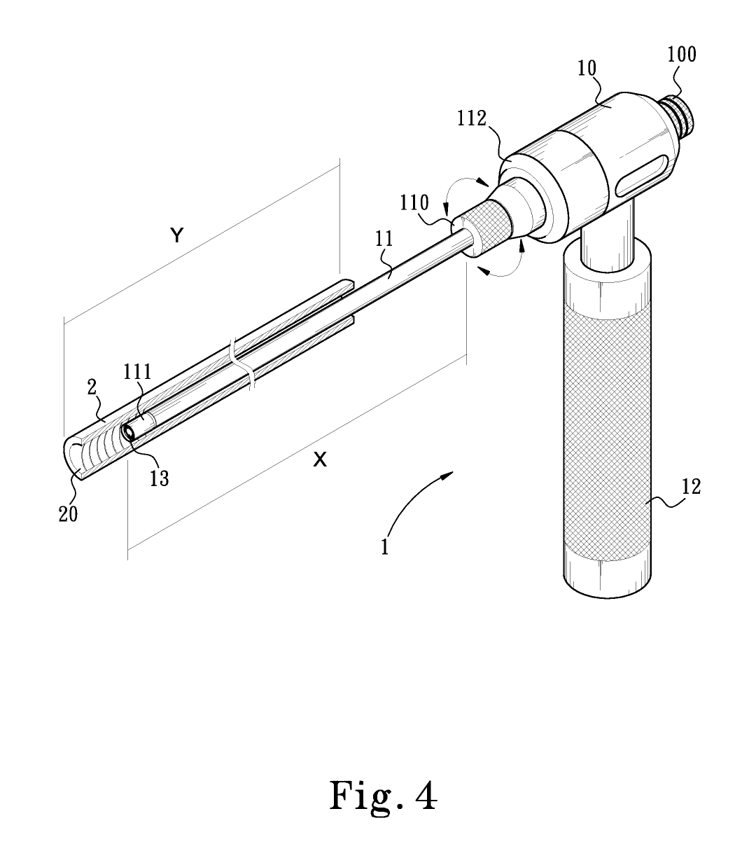

Please refer to FIG. 4, which is a schematic view showing that the endoscope with a rigid body according to the present invention is inserted into a channel for inspection. The endoscope 1 has the rod 11 connected to the front end of the base 10. The rod 11 has the knob 110. The peripheral surface of the base 10 is connected to the handle portion 12. The rear end of the base 10 is provided with the connecting portion 100. The rod 11 is a straight rigid rod. One end of the rod 11 is provided with the inspection module 13. The cap 111 is threadedly connected to one end of the rod 11 for protecting the inspection module 13 from suffering damage. The inspection module 13 includes the lens 130 and the plurality of light-emitting devices 131, which is not shown in FIG. 4 and please refer to FIG. 2A. The rod 11 has a small diameter, so that it can be inserted into a small channel 2. The light-emitting device 131 illuminates the interior of the channel 2. The lens 130 is inserted into the channel 2 for inspecting or recording the interior of inner walls 20 of the channel 2. The length X of the rod 11 connected to one end of the base 10 is changeable based on the length Y of the channel 2, thereby inspecting the channels 2 of different lengths.

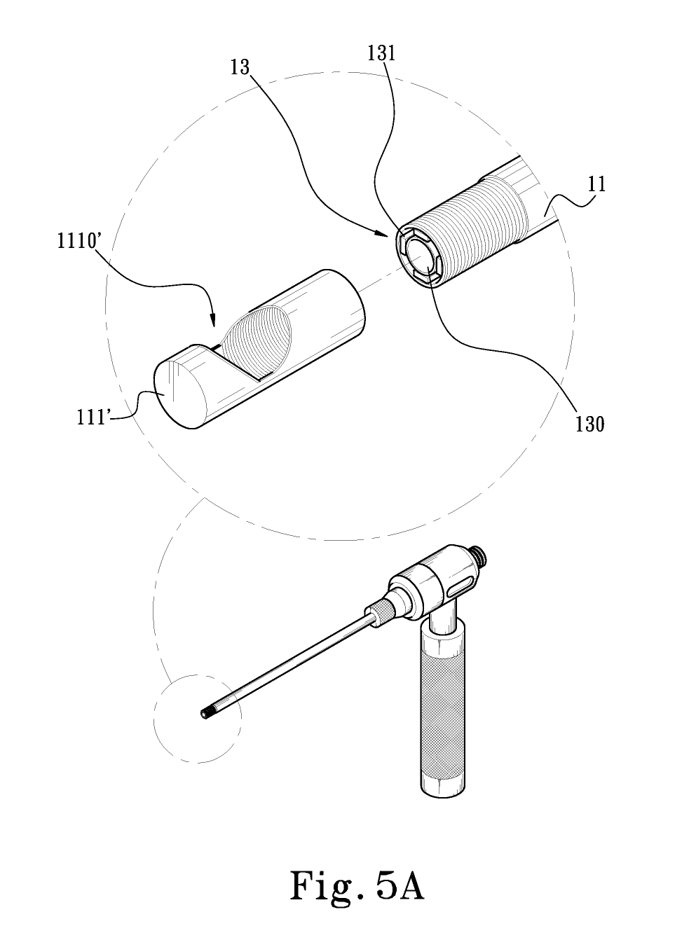

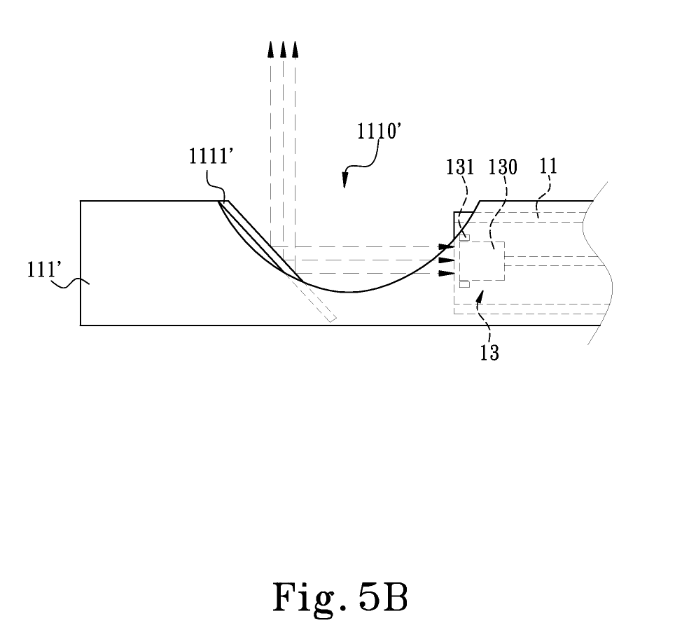

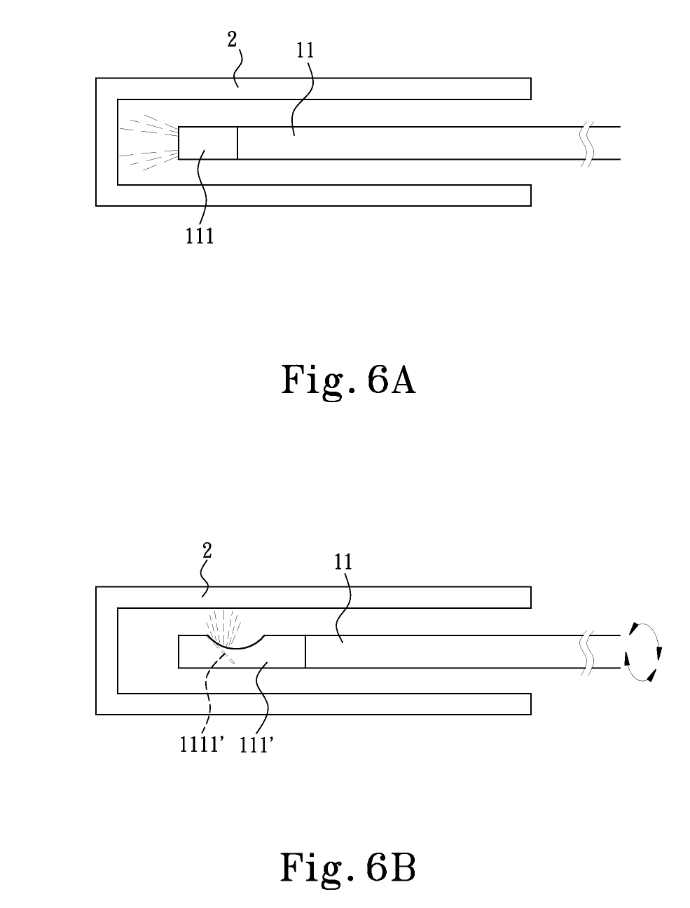

Please refer to FIGS. 5A, 5B, 6A and 6B, which show the cap used in the industry endoscope with a rigid body according to the present invention. Please also refer to FIGS. 2A and 4. One end of the rod 11 of the endoscope 1 of the present invention is provided with the inspection module 13. The outer surface of one end of the rod 11 is provided with outer threads, so that the cap 111 can be threadedly connected thereto for protecting the end of the rod 11. In order to inspect the conditions of the inner peripheral walls of the channel 2, the cap 111 can be replaced by another cap 111′ to cover the end of the rod 11. The cap 111′ is a tubular body having an opening 1110′ on its one side. The inner wall of the cap 111′ is formed with inner threads, so that the cap 111′ can be threadedly connected to one end of the rod 11. The inner wall of the opening 1110′ of the cap 111′ is provided with an inclined reflector 1111′. The reflector 111′ may be a magnifier. When the cap 111′ is threadedly connected to one end of the rod 11, the inspection module 13 is located to correspond to the reflector 111′. When the inspection module 13 is inserted into the channel 2 for inspection, the reflector 1111′ reflects the light emitted by the inspection module 3 for illumination. When a closed channel 2 is to be inspected, different caps 111 and 111′ may be provided on one end of the rod 11. The cap 111 is configured to direct the light emitted by the inspection module 2 to a region in front of the cap 111 for a forward inspection. The other cap 111′ is provided with a reflector 111′ having an inclination angle in a range of 35 to 70 degrees, 45 to 90 degrees and 55 to 110 degrees. By this arrangement, as shown in FIGS. 6A and 6B, the light emitted by the inspection module 13 can be directed to different angular locations on the inner walls of the channel 2 for inspection. When the endoscope 1 is connected to the display device 3 as shown in FIG. 3, the display device 3 can control the inspection module 13 on the front end of the rod 11 to take pictures and record. By using the caps 111, the direction of taking pictures or recording can be guided to the region in front of the inspection module 13. Alternatively, the reflector 1111′ of the cap 111′ reflects the light emitted by the inspection module 3 to different angular locations on the inner wall of the channel 2. By rotating the knob 110 provided on one end of the inspection module 13 relative to its axial line up to 360 degrees, as shown in FIG. 4, the inspection module 13 can inspect the interior of the channel 2 relative to its axial line completely. By using different caps 111 and 111′, the user can inspect the forward location or different angular locations on the inner walls 20 of the channel 2. Further, the inspection module 13 rotates in the channel 2 to 360 degrees, so that the tiny portions on the inner walls of a small channel of an industry precision machine can be inspected accurately.

What is claimed is:

1. An industry endoscope with a rigid body, the endoscope including a base, a rod and a handle portion, one end of the handle portion being connected to one side of the base, one end of the base being connected to the rod having a knob, the other end of the base being provided with a connecting portion, an inner edge of one free end of the rod opposite to the knob being provided with an inspection module, a hollow cap being provided on the periphery of the free end of the rod, characterized in that:
the rod is a straight and rigid rod, one end of the rod is provided with the knob to be connected to one side of the base, the free end of the rod is provided with the inspection module, the inspection module comprises a lens and a plurality of LED devices, the cap is threadedly connected to the outer periphery of the free end of the rod, the rotation of the knob and the rod causes the inspection module to rotate 360 degrees relative to its axial line, so that the inspection module can be inserted into a small channel for inspection.

2. The industry endoscope with a rigid body according to claim 1, wherein one side of an outer surface of the cap is provided with an opening, a reflector is provided inside the opening, so that the inspection module can inspect different angular locations inside the small channel.

3. The industry endoscope with a rigid body according to claim 2, wherein the reflector is a magnifier.

4. The industry endoscope with a rigid body according to claim 2, wherein the reflector is configured to have an inclination angle in a range of 35 to 70 degrees, 45 to 90 degrees, and 55 to 110 degrees.

5. The industry endoscope with a rigid body according to claim 1, wherein the length of the rod is changeable based on practical demands.

6. The industry endoscope with a rigid body according to claim 1, wherein the connecting portion of the base is connected to a display device.
